(19) United States
(12) Patent Application Publication
(10) Pub. No.: US 2024/0272620 A1
(43) Pub. Date: Aug. 15, 2024

(54) METHOD AND COMPUTER PROGRAM PRODUCT FOR IMPROVING A PRODUCTION PLAN FOR PRODUCING A THREE-DIMENSIONAL COMPONENT FROM A METAL SHEET

(71) Applicant: Optimate GmbH, Stuttgart (DE)

(72) Inventors: Jonas Steiling, Ludwigsburg (DE); Max Hesselbarth, Stuttgart (DE)

(21) Appl. No.: 18/644,177

(22) Filed: Apr. 24, 2024

Related U.S. Application Data
(63) Continuation of application No. PCT/EP2022/079542, filed on Oct. 24, 2022.

(30) Foreign Application Priority Data
Oct. 25, 2021 (DE) 10 2021 127 648.9

(51) Int. Cl. G05B 19/4155

(52) U.S. Cl. CPC G05B 19/4155; G05B 2219/35005

(57) ABSTRACT

An improved production plan is created for producing a three-dimensional component from a metal sheet by cutting, bending, and/or welding. A method creates the improved production plan by: dividing a first two-dimensional construction plan of the original production plan along bending edges, or the bending edges and weld seams, into surfaces; rearranging the surfaces to form a second two-dimensional construction plan, assessing the construction plans according to a length of an outer contour for cutting the component out of the metal sheet, a length of the weld seams, or a number of bends; and producing the improved production plan from the second construction plan based upon the assessment of the second construction plan being better than the assessment of the first construction plan.

### CROSS REFERENCE TO RELATED APPLICATIONS

This application is a continuation of International Application No. PCT/EP2022/079542 (WO 2023/072808 A1), filed on Oct. 24, 2022, and claims benefit to German Patent Application No. DE 10 2021 127 648.9, filed on Oct. 25, 2021. The aforementioned applications are hereby incorporated by reference herein.

### FIELD

The present disclosure relates to a method for improving a production plan for producing a three-dimensional component from a metal sheet.

The present disclosure furthermore relates to a computer program product for improving a production plan for producing a three-dimensional component from a metal sheet.

### BACKGROUND

Three-dimensional components can be produced from a metal sheet by means of cutting and bending and/or welding. Here, a component can be produced from a metal sheet in various ways. In particular, the two-dimensional development of the component may differ. From this it follows that different edges of the component must be bent or welded. The different ways of production differ in their cost.

### SUMMARY

In an embodiment, the present disclosure provides an improved production plan that is created for producing a three-dimensional component from a metal sheet. The three-dimensional component is to be produced from the metal sheet according to an original production plan by cutting and bending and/or welding. The original production plan has a first two-dimensional construction plan. The first construction plan has an outer contour for cutting the three-dimensional component out of the metal sheet. The first construction plan has one or more bending edges or the one or more bending edges and one or more weld seams. A method creates the improved production plan by: dividing the first construction plan along the bending edges, or the bending edges and the weld seams, into surfaces; rearranging the surfaces to form at least one second two-dimensional construction plan, the three-dimensional component being capable of being produced from the second construction plan; assessing the construction plans according to a length of the outer contour, a length of the weld seams, and/or a number of bends; and producing the improved production plan from the at least one second construction plan based upon the assessment of the at least one second construction plan being better than the assessment of the first construction plan.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of an exemplary three-dimensional component;

FIG. 2 shows a two-dimensional development of the component from FIG. 1;

FIG. 3 shows a subdivided two-dimensional development of the component from FIG. 1;

FIG. 4 shows a first graph created from the development shown in FIG. 3;

FIG. 5 shows a second graph created from the graph shown in FIG. 4;

FIG. 6 shows a second development created from the graph shown in FIG. 5;

FIG. 7 shows a schematic view of a component produced from the development shown in FIG. 6;

FIG. 8 shows the first development from FIG. 2 with two stability paths;

FIG. 9 shows the second development from FIG. 6 with two stability paths; and

FIG. 10 shows the two developments from FIGS. 2 and 6 in comparison.

### DETAILED DESCRIPTION

Aspects of the present disclosure provide a method and a computer program product that improve an available production plan. More rapid and/or less expensive creation of the three-dimensional component is thereby made possible.

According to an aspect of the present disclosure, a method for improving a production plan for producing a three-dimensional component from a metal sheet is provided, wherein the component is to be produced from the metal sheet according to the production plan by means of cutting and bending and/or welding, wherein the production plan comprises a first two-dimensional construction plan, wherein the first construction plan has an outer contour for cutting the component out of a metal sheet, wherein the first construction plan has at least one bending edge and optionally one or more weld seams, wherein the first construction plan is divided along bending edges and weld seams into surfaces, wherein the surfaces are rearranged to form at least one second two-dimensional construction plan, wherein the three-dimensional component can be produced from the second construction plan, wherein the construction plans are assessed according to the length of the outer contour, the length of the weld seams and/or the number of bends, wherein the improved production plan is produced from at least one second construction plan if the assessment of the second construction plan is better than the assessment of the first construction plan.

The two-dimensional construction plan comprises a two-dimensional development of the component. The development describes the shape that is to be cut out of the metal sheet. The shape comprises an outer contour and optionally apertures within the outer contour. The apertures can be created by means of cutting or punching, for example. In addition, the construction plan comprises bending edges with bending directions and bending angles. If one or more weld seams are provided, the construction plan also includes instructions as to which edges of the metal sheet are to be welded. Bending edges are located within the outer contour, and weld seams are each located along two regions of the outer contour which are to be welded together.

In addition, the production plan can include information on the material to be used and/or the sheet thickness.

To enable the three-dimensional component to be produced from the second construction plan, the connection between the surfaces is retained in the arrangement for a second construction plan. This means that surfaces which are joined via a bending edge or a weld seam in the first construction plan are also connected via a bending edge or a weld seam in the second construction plan. However, the joining method may differ between the first construction plan and the second construction plan.

The assessment of the construction plans provides a measure of the costs and/or production time for the component. Here, the assessment metrics can be adapted by the user of the method. For example, the user may specify costs and/or a time for carrying out a welding operation of a particular length, a cutting operation of a particular length and/or a bending operation. Moreover, the assessment metrics may depend on the material and/or the sheet thickness.

In order to create a production plan from the second construction plan, the second construction plan is, if appropriate, combined with information from the first production plan that is not included in the second construction plan. Such information can comprise information on the material to be used and/or the sheet thickness, for example.

As a preferred option, a graph is produced from the first construction plan, wherein the corners of the graph represent the surfaces of the construction plan, and the edges of the graph represent the connections between the surfaces, wherein an edge in the graph can represent a weld seam, a bending edge, a material connection or an absent connection, wherein, to produce the second construction plan, the represented connection is modified at least for some of the edges of the graph. The use of the graph ensures in a very simple way that the connection between the surfaces is retained in arranging the surfaces to form a second construction plan. By changing the way in which the edges are represented in the graph, the type of connection between the surfaces can be modified.

It is advantageous that an edge in the graph can represent a material connection only between surfaces which are in the same plane and adjoin one another. Surfaces which adjoin one another but are not in one plane can be joined by means of a weld seam, a bending edge or an absent connection. Surfaces which adjoin one another and are in one plane can be joined by means of a material connection, a weld seam or an absent connection.

Preferably, a rectangle of minimum area surrounding the outer contour is determined for each of the construction plans, and the area of the rectangle is included in the assessment of the respective construction plan. By determining the minimum surrounding rectangle, a measure of the consumption of material is determined. Alternatively or in addition, the ratio of the area of the surrounding rectangle to the area of the sheet metal used, i.e. a measure of the waste, can enter into the assessment of the respective construction plan.

In a preferred embodiment, the first construction plan has at least one fastening point, wherein the surface in which the fastening point is located is a fastening surface, wherein stability paths between the fastening surfaces are determined for each construction plan, wherein a stability path begins on a fastening surface and ends on a fastening surface, wherein a stability path connects surfaces via bending edges and/or weld seams and/or material connections, wherein a second construction plan is assessed as a stable construction plan if all the surfaces which are connected to a fastening surface via a stability path in the first construction plan are also connected to a fastening surface via a stability path in the second construction plan.

The stability paths are used to check the three-dimensional shape stability of the component. Surfaces which are traversed by a stability path will retain their position relative to the other components in the component produced. The stability paths can therefore be used to ascertain which surfaces in the first construction plan should be stable relative to one another. In the second construction plan, the stability paths can be used to check whether the same surfaces will be stable relative to one another.

Preferably, only second construction plans which are deemed to be stable are assessed. Arbitrary changes in the connections between the surfaces may result in unstable construction plans. Although the three-dimensional component can be produced from unstable construction plans, a component produced in this way will very probably not fulfil the purpose contemplated. By checking the stability by means of the stability paths, it is possible to ensure the stability of the components produced from a second construction plan. By using the stability paths, it is possible, for example, to eliminate possibly unnecessary weld seams if the component is stable even without these weld seams.

A fastening surface contains at least one fastening point and is therefore inherently stable. If there is a fastening point present, it can be assumed that the fastening surface is fastened to some other stable component and therefore will have a stable position. All other surfaces must be traversed by a stability path if they are to be stable. A stability path begins at a fastening surface and ends at a fastening surface. Since the fastening surfaces cannot change their position relative to one another in the component produced, the surfaces traversed by the stability path will also retain their position relative to the fastening surfaces. The stability paths thus guarantee that surfaces which are not fastening surfaces have a stable position relative to the fastening surfaces. Surfaces which are not traversed by a stability path in the first construction plan are not taken into account in the assessment of whether the component is stable since these do not have a stable position relative to the fastening surfaces even in the first construction plan.

A stability path preferably crosses each bending edge or weld seam no more than once. This restriction improves the stability checking of the construction plan. The stability path will therefore not leave a surface via the same bending edge or weld seam via which it reached the surface. A stability path which reaches and leaves a surface via the same bending edge or weld seam does not reveal anything about the surface.

The stability path is preferably determined in the graph. Determining the stability path in the graph is particularly simple. It should be noted that edges in the graph which represent an absent connection must not be crossed by the stability path.

In one preferred embodiment, the first construction plan has at least two fastening points, wherein the at least two fastening points are located in a first surface, wherein the first surface is divided into two fastening surfaces between the two fastening points.

Fastening points can be detected automatically, e.g. if there are holes of a predetermined size in the surface. In this case, the holes can be produced by cutting or punching. There is a material connection between the two fastening surfaces. Consequently, an edge in the graph between the two fastening surfaces represents a material connection. The material connection is preferably changed to an absent connection. Since fastening surfaces are inherently stable, this change has no effects on the stability of the component.

In creating the second construction plan, one weld seam is preferably changed to a bending edge or a material connection. The changing of one weld seam to a bending edge is performed on surfaces which are to be welded at an angle in the first construction plan. The changing of one weld seam to a material connection is performed on surfaces which are to be welded in one plane in the first construction plan.

In creating the second construction plan, one material connection is preferably changed to an absent connection. This is particularly preferred if a surface is divided into a plurality of surfaces since there is a plurality of fastening points present in the surface.

In one preferred embodiment, the three-dimensional component is produced according to the improved production plan by means of one or more machine tools. Machine tools are machines which can carry out one or more work steps comprising cutting, punching, bending and welding. In this way, the component is produced particularly economically and/or quickly.

The method is preferably carried out as a computer-implemented method.

The present disclosure also comprises a computer program product for carrying out a method according to the present disclosure.

Commands for carrying out a method according to the present disclosure by means of a computer are preferably stored on a non-volatile computer-readable storage medium.

The following description of exemplary embodiments serves to explain the present disclosure in greater detail in association with the drawings.

Elements that are the same or have equivalent functions are denoted by the same reference signs in all the exemplary embodiments. In the figures, bending edges are illustrated in dashed lines. In the figures, weld seams are illustrated by dash-dot lines. In the figures of the graphs, absent connections are illustrated by dotted lines.

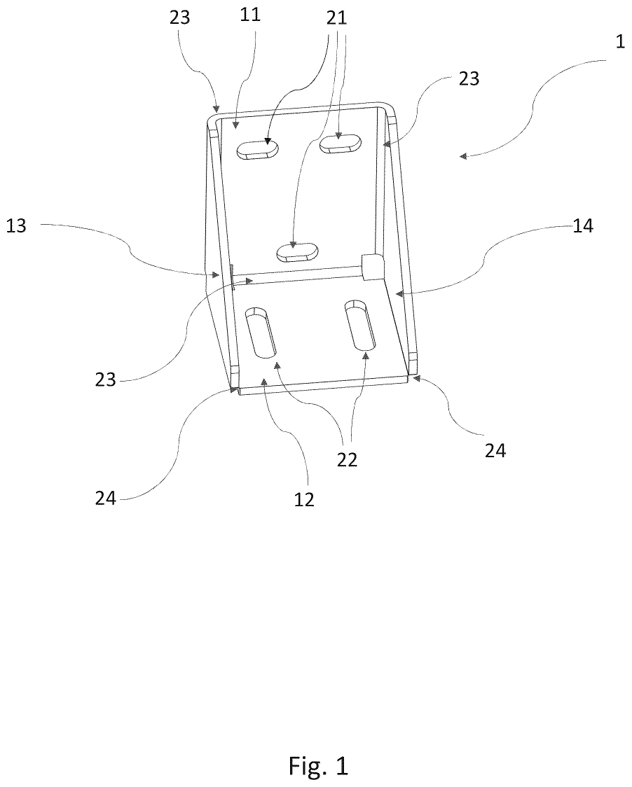

FIG. 1 shows a schematic view of a three-dimensional component 1. The three-dimensional component 1 consists of four surfaces. In a first surface 11, there are three holes 21. In a second surface 12, there are two slotted holes 22. A third surface 13 and a fourth surface 14 serve for the stability of the component. Bending edges 23 are provided between the first surface 11 and the second surface 12, between the first surface 11 and the third surface 13, and between the first surface 11 and the fourth surface 14. Weld seams 24 are provided between the second surface 12 and the third surface 13, and between the second surface 12 and the fourth surface 14.

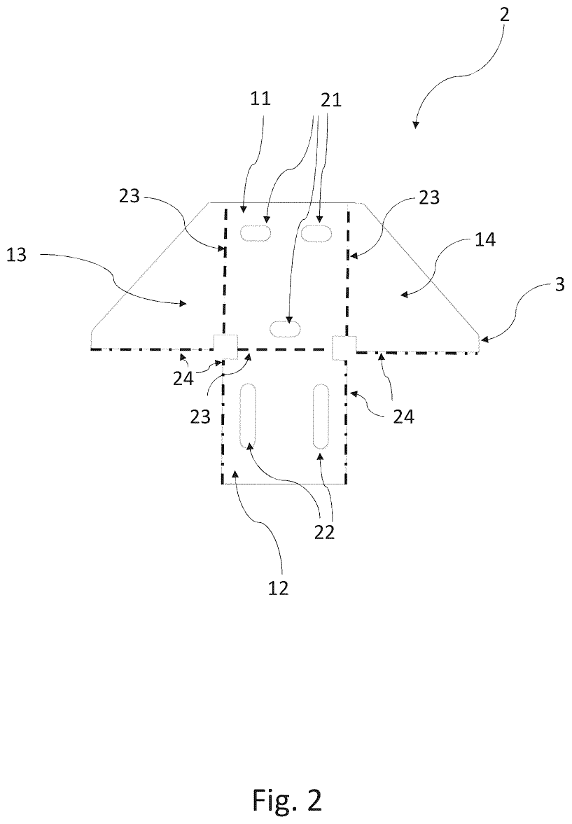

FIG. 2 shows a two-dimensional first development of the component from FIG. 1. The construction plan is divided into surfaces along bending edges 23. In the first surface 11, the three holes 21 are detected as fastening points, and, in the second surface 12, the two slotted holes 22 are detected as fastening points. The weld seams 24 are in each case provided between the surfaces in regions of the outer contour 3 of the second, third and fourth surfaces 12, 13, 14.

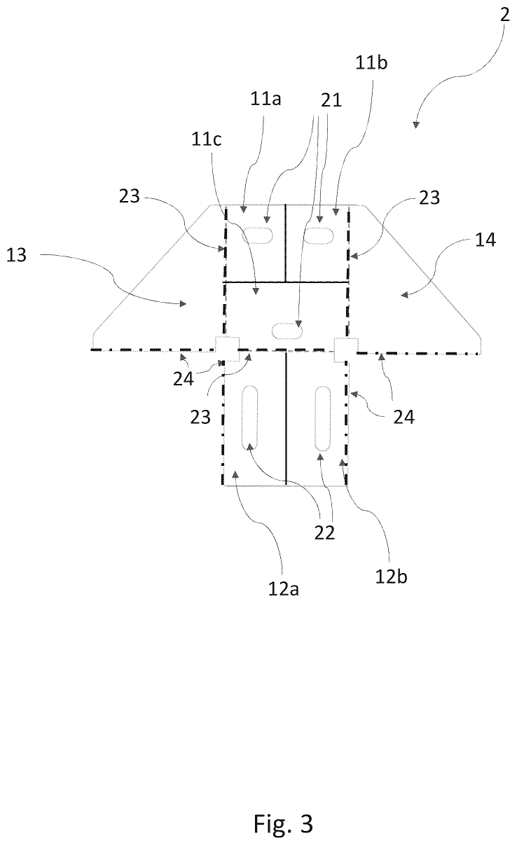

FIG. 3 shows a subdivided two-dimensional development of the component from FIG. 1. The first surface 11 is subdivided between the three holes 21, that is to say the fastening points, in such a way that each surface 11a, 11b, 11c formed contains just one fastening point 21. There is a material connection between each of the surfaces 11a, 11b, 11c formed. The second surface 12 is likewise subdivided between the slotted holes 22 in such a way that each surface 12a, 12b formed contains just one fastening point 21. There is a material connection between each of the surfaces 12a, 12b formed. The five surfaces 11a, 11b, 11c, 12a, 12b thus formed are fastening surfaces.

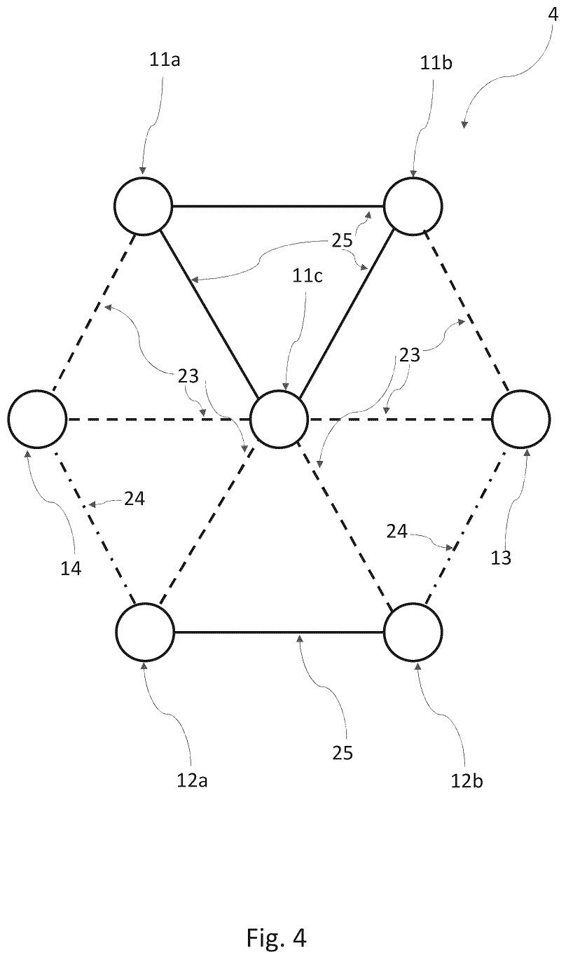

FIG. 4 shows a first graph 4 created from the development 2 shown in FIG. 3. The nodes of the graph 4 represent the surfaces of the component 1. The edges of the graph 4 represent the connections between the surfaces. The first surface 11 was divided into three fastening surfaces 11a, 11b, 11c, and therefore a material connection 25 is represented between each of these fastening surfaces 11a, 11b, 11c. The second surface 12 was divided into two fastening surfaces 12a, 12b, and therefore a material connection 25 is represented between each of these fastening surfaces. The other edges of the graph 4 represent the corresponding bending edges 23 and weld seams 24 between the surfaces.

Second construction plans are created from the graph of the first construction plan 2 shown in FIG. 4 by modifying the types of connections represented. Typically, bending edges can be produced more advantageously and more quickly than weld seams, and therefore weld seams are preferably changed to bending edges. Material connections between fastening surfaces can often be replaced by absent connections.

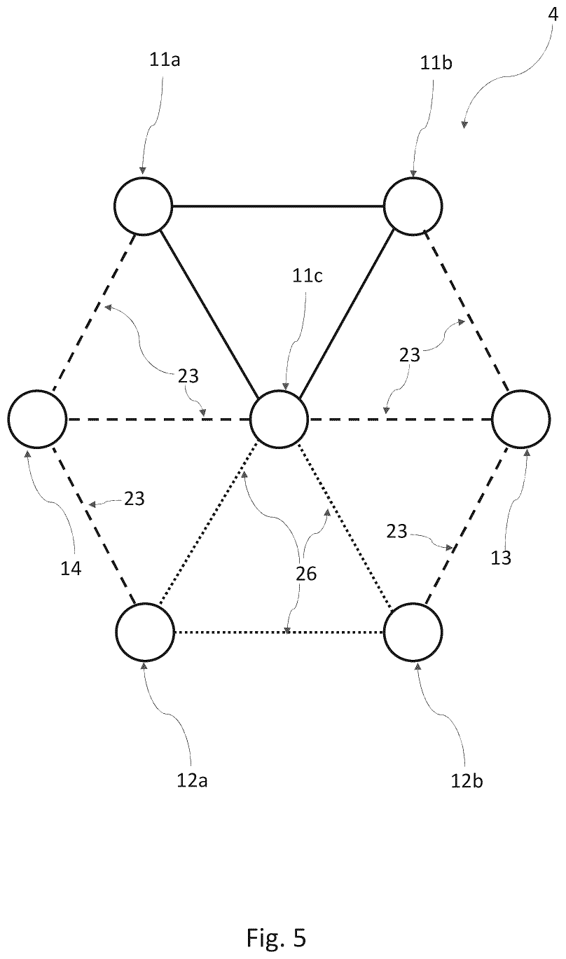

FIG. 5 shows a second graph 4 created from the graph shown in FIG. 4. In comparison with the first graph, the two weld seams 24 have been replaced by bending edges 23. The bending edges 23 between the first surface 11 and the second surface 12 have been replaced by absent connections 26. The material connection 25 between the two fastening surfaces 12a, 12b formed from the second surface 12 has likewise been replaced by an absent connection 26.

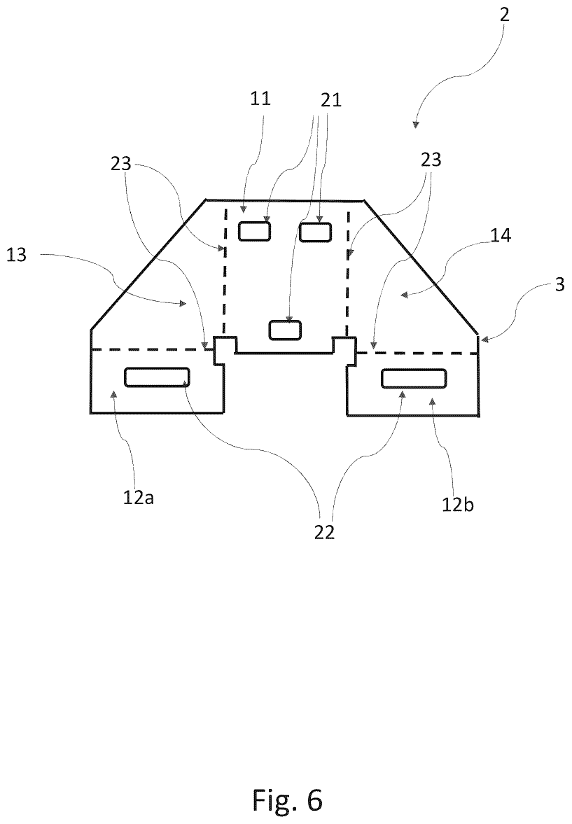

FIG. 6 shows a second development 2 created from the second graph 4 shown in FIG. 5. In contrast to the first development shown in FIG. 2, the second surface 12 is no longer a continuous surface; instead, the two fastening surfaces 12a, 12b formed from the second surface 12 are respectively connected via bending edges 23 to the third surface 13 and the fourth surface 14.

In the same way, additional second graphs and associated second developments can be created from the first graph shown in FIG. 4. All the developments created in this way are assessed according to the length of the outer contour 3, the length of the weld seams 24 and/or the number of bends 23. Furthermore, the consumption of material can be assessed, e.g. by placing a minimum rectangle around the outer contour and determining its area.

In comparison with the developments 2 from FIG. 2 and FIG. 6, the development 2 from FIG. 6 obviously has a shorter outer contour 3, fewer weld seams 24, less consumption of material and more bending edges 23. Each parameter is preferably assessed individually, wherein the weighting of the parameters can be adapted. The sum of the individual assessments results in the assessment of the construction plan. In sum, the assessment of the second development and hence of the second construction plan from FIG. 6 is therefore better than the assessment of the first development from FIG. 2. Based on the second development 2, an improved production plan is created. Using this production plan, the three-dimensional component can be produced more quickly and economically by means of one or more machine tools than when using the original production plan.

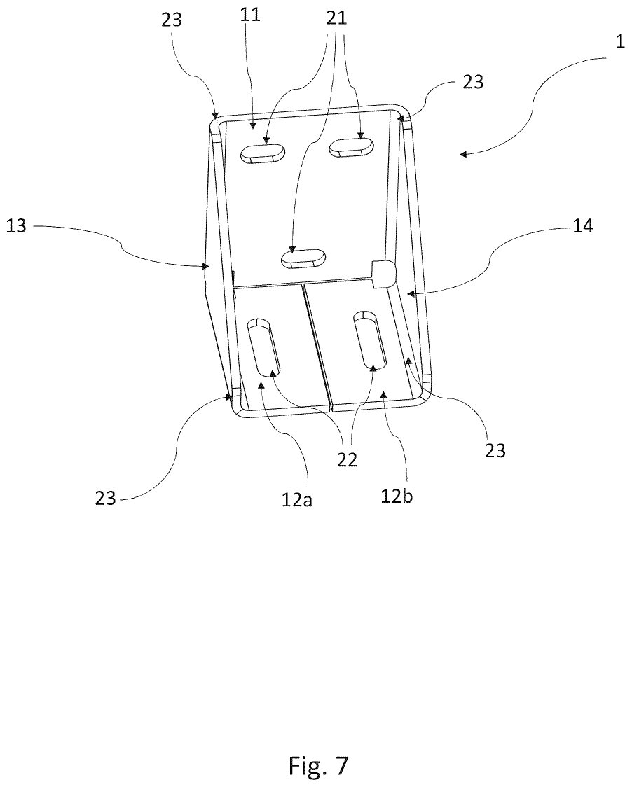

FIG. 7 shows a schematic view of a component produced from the development shown in FIG. 6. In comparison with the component shown in FIG. 1, the second surface 12 is divided into two fastening surfaces 12a, 12b. There is no connection between the two fastening surfaces. There is likewise no connection between the parts of the second surface 12 and the first surface 11. Bending edges instead of weld seams are now present between the third surface 13 and the second surface 12, and between the fourth surface 14 and the second surface 12.

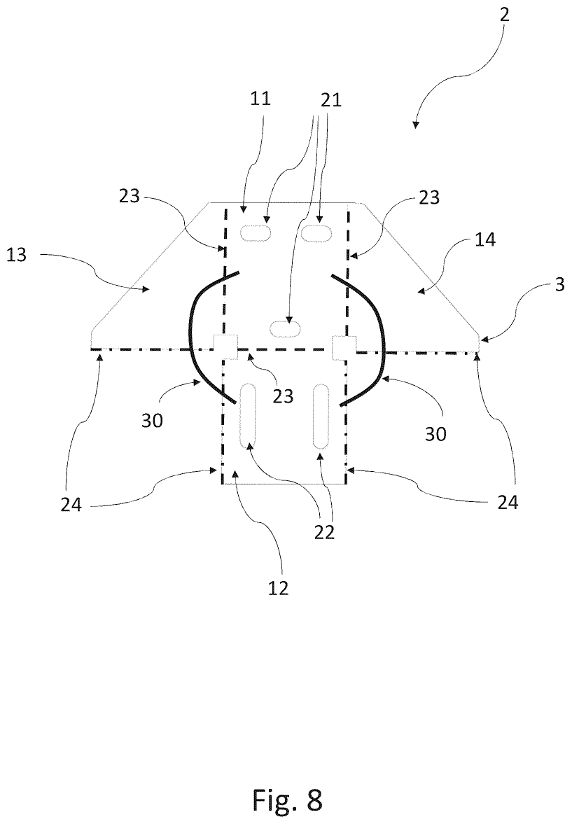

FIG. 8 shows the first development from FIG. 2 with two stability paths 30. A first stability path 30 leads from the first surface 11, via a bending edge 23, to the third surface 13 and, via a weld seam 24, to the second surface 12. A second stability path 30 leads from the first surface 11, via a bending edge 23, to the fourth surface 14 and, via a weld seam 24, to the second surface 12. The stability paths 30 thus satisfy the condition that they each start and end on a fastening surface. The stability paths 30 also satisfy the condition that each bending edge 23 or weld seam 24 is crossed no more than once. Since all the surfaces are traversed by a stability path, the entire component is assessed as stable. The stability paths 30 guarantee that all the surfaces 13, 14 traversed retain a stable position relative to the fastening surfaces 11, 12.

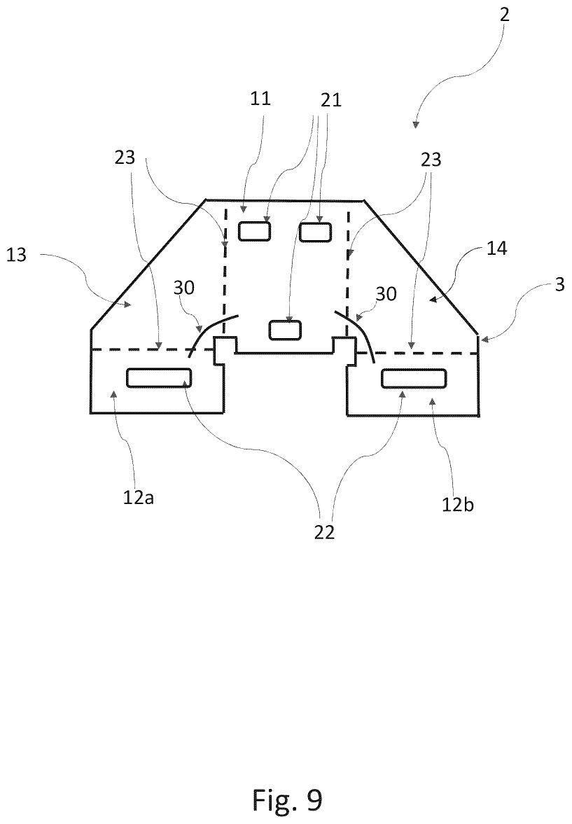

FIG. 9 shows the second development from FIG. 6 with two stability paths 30. A first stability path 30 leads from the first surface 11, via a bending edge 23, to the third surface 13 and, via another bending edge 23, to a fastening surface 12a of the second surface 12. A second stability path 30 leads from the first surface 11, via a bending edge 23, to the fourth surface 14 and, via another bending edge 23, to the other fastening surface 12b of the second surface 12. These stability paths 30 also satisfy the conditions described with reference to FIG. 8, and therefore the entire component is assessed as stable. According to this construction plan too, the traversed surfaces 13, 14 will retain a stable position relative to the fastening surfaces 11, 12.

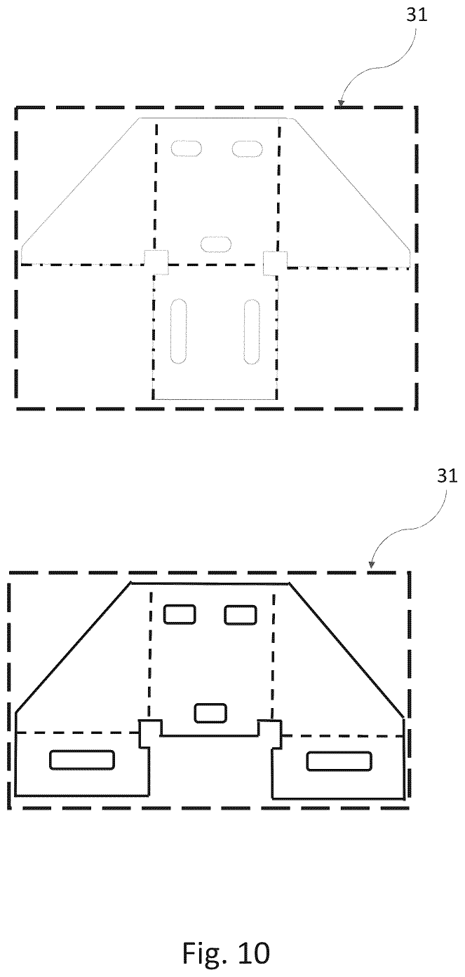

FIG. 10 shows the two developments from FIGS. 2 and 6 in comparison. In association therewith, the respective minimum rectangle 31 is shown. The minimum rectangle is a surrounding rectangle with a minimum area. That is to say that the minimum rectangle surrounds the development with a minimum area. It can be clearly seen in FIG. 10 that the minimum rectangle in the case of the development from FIG. 2 requires a significantly larger area than the minimum rectangle in the case of the development from FIG. 6. The area of the minimum rectangle 31 enters into the assessment of the respective construction plan as a measure of the consumption of material.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Component
2 Construction plan
3 Outer contour
4 Graph
11 First surface
12 Second surface
13 Third surface
14 Fourth surface
21 Hole, fastening point
22 Slotted hole, fastening point
23 Bending edge
24 Weld seam
25 Material connection
26 Absent connection
30 Stability path
31 Minimum rectangle

1. A method for improving a production plan for producing a three-dimensional component from a metal sheet, the three-dimensional component to be produced from the metal sheet according to the production plan by cutting and bending and/or welding, the production plan comprising a first two-dimensional construction plan, the first construction plan having an outer contour for cutting the three-dimensional component out of the metal sheet, the first construction plan comprising one or more bending edges or the one or more bending edges and one or more weld seams, the method comprising:
dividing the first construction plan along the bending edges, or the bending edges and the weld seams, into surfaces;
rearranging the surfaces to form at least one second two-dimensional construction plan, the three-dimensional component being capable of being produced from the second construction plan;
assessing the construction plans according to a length of the outer contour, a length of the weld seams, and/or a number of bends; and
producing the improved production plan from the at least one second construction plan based upon the assessment of the at least one second construction plan being better than the assessment of the first construction plan.

2. The method according to claim 1, the method further comprising producing a graph from the first construction plan,
wherein corners of the graph represent the surfaces of the construction plan, and edges of the graph represent connections between the surfaces,
wherein an edge, of the edges, in the graph represents a connection that is a weld seam, a bending edge, a material connection, or an absent connection,
wherein, to produce the second construction plan, the represented connection is modified at least for some of the edges of the graph.

3. The method according to claim 2, wherein
an edge, of the edges, in the graph is configurable to represent a material connection only between surfaces which are in the same plane and adjoin one another.

4. The method according to claim 1, the method further comprising:
determining a rectangle of minimum area surrounding the outer contour is for each of the construction plans,
wherein the area of the rectangle is included in the assessment of the respective construction plan.

5. The method according to claim 1,
wherein the first construction plan has at least one fastening point,
wherein the surface in which the fastening point is located is a fastening surface,
wherein the method further comprises determining stability paths between the fastening surfaces for each construction plan,
wherein a stability path begins on a fastening surface and ends on a fastening surface,
wherein a stability path connects surfaces via bending edges and/or weld seams and/or material connections,
wherein the method further comprises assessing a second construction plan as a stable construction plan based on determining that all the surfaces which are connected to a fastening surface via a stability path in the first construction plan are also connected to a fastening surface via a stability path in the second construction plan.

6. The method according to claim 5, wherein:
a stability path crosses each bending edge or weld seam no more than once.

7. The method according to claim 5, the method further comprising producing a graph from the first construction plan,
wherein corners of the graph represent the surfaces of the construction plan, and edges of the graph represent connections between the surfaces,
wherein an edge, of the edges, in the graph represents a connection that is a weld seam, a bending edge, a material connection, or an absent connection,
wherein, to produce the second construction plan, the represented connection is modified at least for some of the edges of the graph, and
wherein the stability path is determined in the graph.

8. The method according to claim 1,
wherein the first construction plan has at least two fastening points,
wherein the at least two fastening points are located in a first surface,
wherein the first surface is divided into two fastening surfaces between the two fastening points.

9. The method according to claim 1, wherein in creating the second construction plan, one weld seam is changed to a bending edge or a material connection.

10. The method according to claim 1, wherein in creating the second construction plan, one material connection is changed to an absent connection.

11. The method according to claim 1, wherein the method further comprises producing the three-dimensional component according to the improved production plan using one or more machine tools.

12. A non-transitory computer-readable storage medium comprising instructions for a computer to carrying out the method according to claim 1.
